(19) United States
(12) Patent Application Publication
(10) Pub. No.: US 2019/0176737 A1
(43) Pub. Date: Jun. 13, 2019

(54) AUTOMATIC UNLOCKING DEVICE FOR VEHICLES

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventor: Tatsuya WATANABE, Yokkaichi-shi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 16/075,214

(22) PCT Filed: Feb. 8, 2017
(86) PCT No.: PCT/JP2017/004575

§ 371 Date: Aug. 3, 2018

(30) Foreign Application Priority Data
Feb. 29, 2016 (JP) 2016-037332

(51) Int. Cl. B60R 21/12; G06K 9/00; G07C 9/00

(52) U.S. Cl. CPC B60R 21/12; G06K 9/00362; B60W 40/105; G07C 9/00182; G06K 9/00805

(57) ABSTRACT

The automatic unlocking device for a vehicle causes a monitoring device to monitor a suspicious person around the vehicle if the vehicle is in the predetermined movement stop state. If no suspicious person is detected, a door of the vehicle is unlocked, and if a suspicious person is detected, the door of the vehicle is kept locked.

### TECHNICAL FIELD

The present disclosure relates to an automatic unlocking device for a vehicle.

This application is based upon and claims the benefit of priority from Japanese Patent Application No. 2016-037332, filed on Feb. 29, 2016, the entire content of which is incorporated, herein by reference.

### BACKGROUND ART

Known is an automatic locking device for a vehicle configured to automatically lock doors of the vehicle when a certain time period has elapsed after the vehicle starts moving. Also, known is an automatic unlocking device for a vehicle configured to determine a situation in which a user gets off the vehicle and automatically unlock the doors (for example, Patent Document 1). If a shift lever of a vehicle provided with an automatic transmission is shifted to a parking position, for example, the automatic unlocking device for a vehicle automatically unlocks doors in anticipation of the possibility that the user will get off the vehicle. According to these automatic locking device for a vehicle and automatic unlocking device for a vehicle, it is possible to improve the convenience at the time of getting in and getting off the vehicle.

### CITATION LIST

### Patent Documents

Patent Document 1: JP 2002-4677A

### SUMMARY

### Technical Problem

An automatic unlocking device for a vehicle according to one aspect is an automatic unlocking device for a vehicle configured to automatically unlock a locked door of the vehicle if the vehicle is in a predetermined movement stop state, the automatic unlocking device for a vehicle including a monitoring unit configured to monitor a suspicious person around the vehicle if the vehicle is in the predetermined movement stop state, and a driving unit configured to keep the door locked if a suspicious person is detected by the monitoring unit, and unlock the door if no suspicious person is detected by the monitoring unit.

Note that the present application can be realized as not only the automatic unlocking device for a vehicle including such distinctive processing units but also an automatic unlocking method including a step of performing this distinctive control, or a program for causing a computer to execute such a step. Also, the present application can be realized as a semiconductor integrated circuit that realizes part or all of the automatic unlocking device for a vehicle, or as another system including the automatic unlocking device for a vehicle.

### BRIEF DESCRIPTION OF DRAWINGS

FIG. 1 is a schematic diagram showing one configuration example of an automatic door unlocking system for a vehicle.

FIG. 2 is a block diagram showing one configuration example of an automatic unlocking device for a vehicle.

FIG. 3 is a block diagram showing one configuration example of a monitoring device.

FIG. 4 is a flowchart showing a procedure of processing performed by a controller according to automatic unlocking.

### BEST MODE

When a user parks a vehicle, a suspicious person may suddenly enter the vehicle from its unlocked door, and the user may be victim to a crime. A conventional automatic unlocking device for a vehicle had a security problem because the doors were automatically unlocked regardless of the presence of a suspicious person.

An object of the present disclosure is to provide an automatic unlocking device for a vehicle capable of monitoring a suspicious person around the vehicle when the vehicle is in a predetermined movement stop state in which the user possibly gets off the vehicle, confirming that there is no suspicious person, and automatically unlocking doors of the vehicle.

### Advantageous Effects

An object of the present disclosure is to provide an automatic unlocking device for a vehicle capable of monitoring a suspicious person around the vehicle when the vehicle is in a predetermined movement stop state in which the user possibly gets off the vehicle, confirming that there is no suspicious person, and automatically unlocking doors of the vehicle.

### Description

First, embodiments will be described. Also, at least portions of embodiments described below may be combined.

(1) An automatic unlocking device for a vehicle according to one aspect is an automatic unlocking device for a vehicle configured to automatically unlock a locked door of the vehicle if the vehicle is in a predetermined movement stop state, the automatic unlocking device for a vehicle including a monitoring unit configured to monitor a suspicious person around the vehicle if the vehicle is in the predetermined movement stop state, and a driving unit configured to keep the door locked if a suspicious person is detected by the monitoring unit, and to unlock the door if no suspicious person is detected by the monitoring unit.

According to this aspect, if the vehicle is in the predetermined movement stop state in which the user possibly gets off the vehicle, the monitoring unit monitors the periphery of the vehicle. If a suspicious person is detected around the vehicle, the driving unit keeps the door locked, and if no suspicious person is detected, the driving unit unlocks the door. Thus, the automatic unlocking device for a vehicle can confirm that there is no suspicious person around the vehicle and automatically unlock the door of the vehicle.

(2) It is preferable that the automatic unlocking device for a vehicle includes a dangerous state notification unit configured to give a notification of danger if a suspicious person is detected by the monitoring unit and the door is kept locked.

According to this aspect, if a suspicious person is detected in the predetermined movement stop state and the door is kept locked, the dangerous state notification unit gives a notification of danger. Thus, the user can recognize that the door is not automatically unlocked due to sonic kind of danger outside the vehicle, rather than that there is malfunction in the automatic unlocking function.

(3) It is preferable that the monitoring unit monitors a suspicious person and an obstacle around the vehicle, and the dangerous state notification unit gives a notification of at least a type of suspicious person or obstacle detected by the monitoring unit.

According to this aspect, the dangerous state notification unit gives a notification of the types of suspicious person and obstacle. Thus, the user can recognize what kind of danger exists outside the vehicle and why the door is not automatically unlocked. Examples of the obstacle include a wall and a block with which a door of the vehicle may collide when the door is opened.

(4) It is preferable that the automatic unlocking device for a vehicle includes an unlocking operation detection unit configured to detect an operation for unlocking the door, in which the driving unit unlocks the door if the door is kept locked in the predetermined movement stop state and the unlocking operation is detected by the unlocking operation detection unit.

According to this aspect, even in the situation in which the suspicious person is detected and the door is kept locked, if the unlocking operation detection unit detects the unlocking operation, the driving unit unlocks the door of the vehicle. Thus, if the user can confirm the safety of the outside of the vehicle, the user can unlock the door with his or her intension.

Note that examples of the unlocking operation detection unit include a locking switch of a driver seat and a mechanical locking switch of each door.

(5) It is preferable that the automatic unlocking, device for a vehicle includes a safety state notification unit configured to give a notification of safety if no suspicious person is detected by the monitoring unit.

According to this aspect, the safety state notification unit gives a notification of safety if no suspicious person is detected. Thus, the user can recognize that the outside of the vehicle is in a safety state and the door is automatically unlocked.

### DETAILED DESCRIPTION

Hereinafter, specific examples of an automatic unlocking device for a vehicle 1 according to embodiments will be described with reference to drawings. Note that the embodiment are not limited to these examples, but is indicated by the scope of the claims, and all changes that come within the meaning and range of equivalency of the claims are intended to be embraced therein.

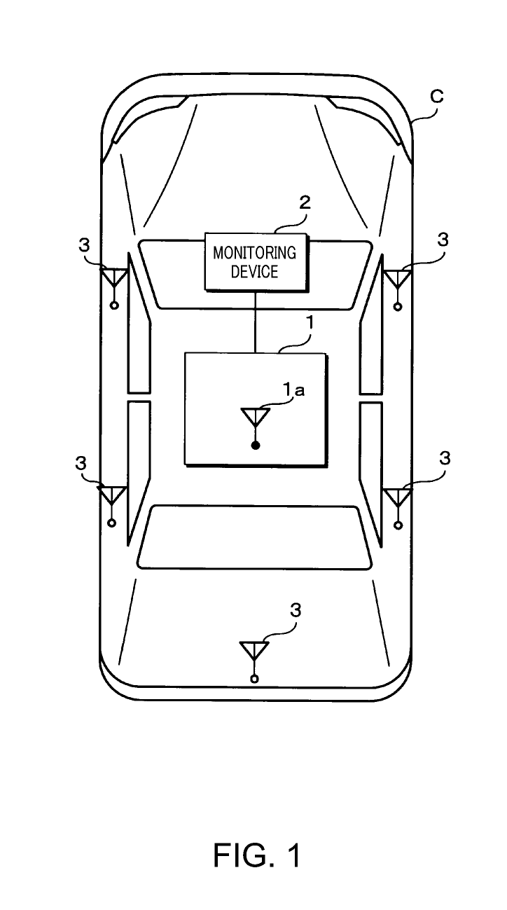

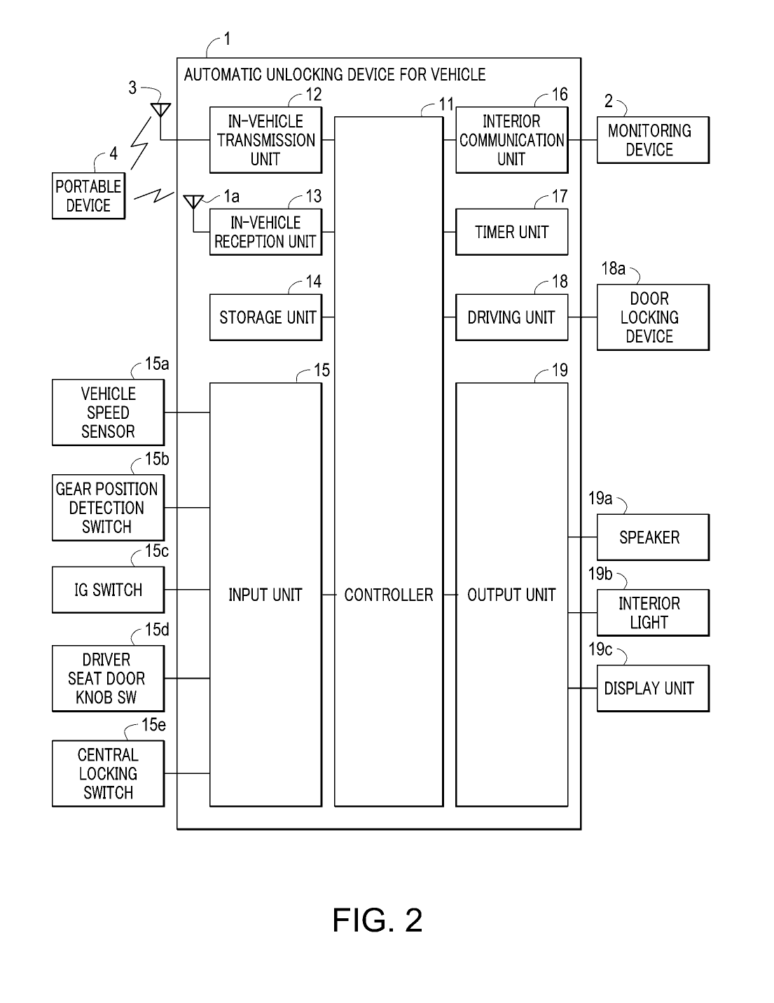

FIG. 1 is a schematic diagram showing one configuration example of an automatic door' unlocking system for a vehicle, and FIG. 2 is a block diagram showing one configuration example of the automatic unlocking device for a vehicle 1. The automatic door unlocking system for a vehicle according to this embodiment includes the automatic unlocking device for a vehicle 1 configured to transmit and receive various signals using a plurality of LF transmission antennas 3 and an RF reception antenna la that are provided in a vehicle C, a monitoring device 2 configured to monitor suspicious persons around the vehicle, and a portable device 4 configured to transmit and receive the signals to/from this automatic unlocking device for a vehicle 1.

The automatic unlocking device for a vehicle 1 includes a controller 11 configured to control operations of the constituent components of the automatic unlocking device for a vehicle 1. The controller 11 is a microcomputer having one or more CPUs (Central Processing Units), or a multicore CPU, for example. The controller 11 is provided with an in-vehicle transmission unit 12, an in-vehicle reception unit 13, a storage unit 14, an input unit 15, an interior communication unit 16, a timer unit 17, a driving unit 18, and an output unit 19,

The controller 11 controls operations of the constituent components by executing a control program that is stored in the storage unit 14 and will be described later, and executes processing related to monitoring of suspicious persons and automatic unlocking of doors.

The in-vehicle transmission unit 12 is connected to the plurality of LF transmission antennas 3, and transmits detection signals for detecting the position of the portable device 4 using LF-band radio waves under the control of the controller 11. The plurality of LF transmission antennas 3 are provided near the doors provided on the vehicle C, for example.

The portable device 4 includes an LF reception antenna for receiving a signal transmitted from the in-vehicle transmission unit 12, an RF transmission antennas for transmitting a signal to the automatic unlocking device for a vehicle 1 using UHF-band radio waves, a locking switch, and an unlocking switch. When receiving a detection signal, the portable device 4 measures the intensity of this received detection signal. The portable device 4 then transmits a response signal including the received signal intensity obtained through measurement to the automatic unlocking device for a vehicle 1 using UHF-band radio waves. Also, if the locking switch is operated, the portable device 4 transmits a locking operation signal including information related to the locking operation to the automatic unlocking device for a vehicle 1. Similarly, if the unlocking switch is operated, the portable device 4 transmits an unlocking operation signal including information related to the unlocking operation to the automatic unlocking device for a vehicle 1.

The in-vehicle reception unit 13 is connected to the RF reception antenna 1a, and receives various signals such as the response signal, the unlocking operation signal, and the locking operation signal that are transmitted from the portable device 4 using UHF-band radio waves. The in-vehicle reception unit 13 outputs the received signals to the controller 11. The controller 11 performs wireless communication with the portable device 4 using the in-vehicle transmission unit 12 and the in-vehicle reception unit 13, and executes processing for receiving the unlocking operation signal and the locking operation signal, processing for authenticating the portable device 4 and processing for detection a position of the portable device, for example. Note that a configuration may also be adopted in which processing for authenticating the portable device 4 and detecting its position is executed by a dedicated ECU, for example.

The storage unit 14 is a non-volatile memory such as an EEPROM (Electrically Erasable Programmable ROM) or a flash memory. The controller 11 controls operations of the constituent components of the automatic unlocking device for a vehicle 1, and thereby, the storage unit 14 stores a control program for executing processing related to monitoring of suspicious persons and automatic unlocking of doors.

A vehicle speed sensor 15a, a gear position detection switch 15b, an ignition (IG) switch 15c, a driver seat door knob switch 15d, and a central locking switch 15e are connected to the input unit 15.

The vehicle speed sensor 15a includes a non-contact sensor provided with a magnetic pickup configured to transmit a signal that is proportional to the number of revolutions of the axle provided in the vehicle C, and a Hall element, for example, and a counting circuit configured to count the number of pulses transmitted from this non-contact sensor. The vehicle speed sensor 15a detects the speed of the vehicle C by measuring the number of pulses. The signal that indicates the vehicle speed detected by the vehicle speed sensor 15a is input to the controller 11, and the controller 11 detects the vehicle speed using this signal that is input to the input unit 15. Note that the non-contact sensor is one example of the vehicle speed sensor 15a, and is not limited to this structure. For example, a configuration may also be adopted in which the vehicle speed sensor 15a acquires information on the position of the vehicle C detected by a GPS and detects the speed of the vehicle C based on a change in the position of the vehicle C.

The gear position detection switch 15b is a switch whose state switches in accordance with the shift position of the shift lever for switching gear positions of the transmission provided in the vehicle C. The gear position detection switch 15b is configured to output, to the controller 11, a signal corresponding to the switching state of the switch. The controller 11 detects the shift position using this signal that is input to the input unit 15.

The ignition switch 15c is for starting a motor of the vehicle C, and is configured to output, to the controller 11, a signal corresponding to the position at which the ignition switch 15c is operated. The controller 11 can recognize whether or not the motor is started or operating, using the signal corresponding to the position at which the ignition switch 15c is operated. If a smart start (registered trademark) system is installed in the vehicle C, a configuration may also be adopted in which a signal related to the state in which the motor is operated by a smart start (registered trademark) button being operated is received and the state in which the motor is operated is recognized.

The driver seat door knob switch 15d outputs, to the controller 11, a signal corresponding to the operating state of a door knob provided on the vehicle interior side of the driver seat. The controller 11 can recognize the operating state of the door knob, based on this signal.

The central locking switch 15e is provided on the vehicle interior side of the driver seat, is for intensively operating locking and unlocking of all of the doors of the vehicle C, and is configured to output, to the controller 11, a signal corresponding to the state in which this switch is operated. The controller 11 can recognize the state in which the central locking switch 15e is operated, based on this signal.

The interior communication unit 16 is a communication circuit configured to perform communication in accordance with a communication protocol such as a CAN (Controller Area Network) or a LIN (Local. Interconnect Network), and the interior communication unit 16 is connected to the monitoring device 2. The interior communication unit 16 transmits an activation signal for instructing activation of the monitoring device 2, a deactivation signal for instructing deactivation of the monitoring device 2, and the like, under the control of the controller 11. Also, the interior communication unit 16 receives a monitoring result transmitted from the monitoring device 2, and the controller 11 acquires the monitoring result via the interior communication unit 16.

The timer unit 17 starts clocking a time period under the control of the controller 11, and provides the controller 11 with the clocking result.

The driving unit 18 is connected to a door locking device 18a. The door locking device 18a includes a locking mechanism for locking and unlocking the doors and an actuator for driving this locking mechanism. If the central locking switch 15e is operated, the controller 11 outputs a locking driving signal or an unlocking driving signal to the actuator of each door, and locks or unlocks the doors.

A speaker 19a, an interior light 19b, and a display unit 190 are connected to the output unit 19.

The interior light 19b is a light-emitting element provided in a door handle or a predetermined site of the door on the inner wall of the vehicle interior, or a room lamp provided on a ceiling portion of the vehicle interior, for example. Also, the interior light 19b may include a light-emitting element configured to switch luminescent colors such as red and blue. The controller 11 turns on/off the interior light 19b by outputting an on signal or an off signal, and controls its light color.

The speaker 19a and the display unit 19c constitute audio and a navigation system, for example. The display unit is a liquid crystal display, for example. The speaker 19a and the display unit 19c output in the form of audio and video that the periphery of the vehicle is in a safe situation or in a dangerous situation, under the control of the controller 11. Also, if the periphery of the vehicle is in a dangerous situation, the speaker 19a and the display unit 19c give notifications of the types of suspicious person and obstacle around the vehicle as the cause of danger.

Although, in FIG. 2, various switches and devices are illustrated as being directly connected to the input unit 15 and the output unit 19 of the automatic unlocking device for a vehicle 1, various switches and devices may also be directly connected with signal wires, connected via an in-vehicle communication network such as a CAN or a LIN, or connected via another ECU.

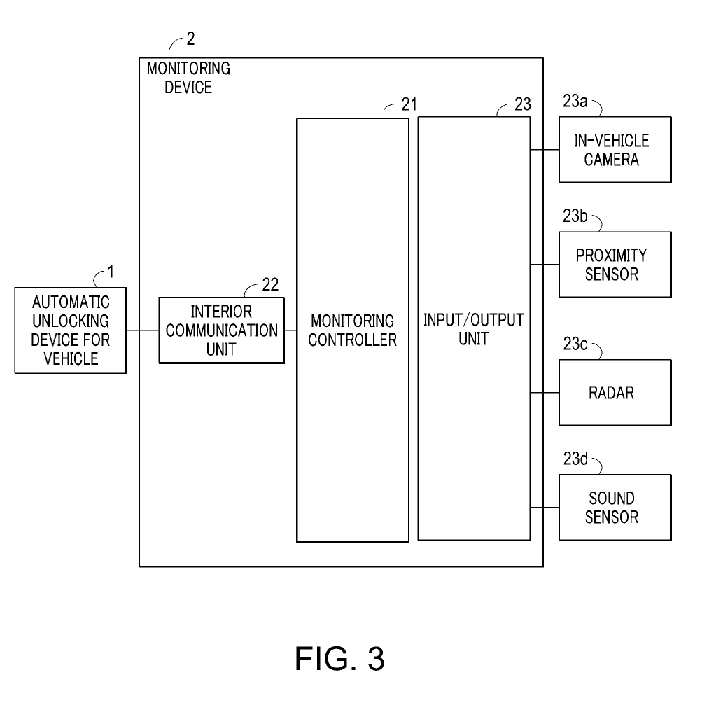

FIG. 3 is a block diagram showing one configuration example of the monitoring device 2. The monitoring device 2 includes a monitoring controller 21, an interior communication unit 22, and an input/output unit 23, and receives power supplied from a power supply device (not shown) to operate. The monitoring controller 21 is a microcomputer having one or more CPUs (Central Processing Units), or a multicore CPU, for example, and controls overall operations of the monitoring device 2. The configuration of the interior communication unit 22 is similar to that of the interior communication unit 16, and the monitoring controller 21 transmits and receives various signals to/from the automatic unlocking device for a vehicle 1 via the interior communication unit 22. If the interior communication unit 22 receives a deactivation signal transmitted from the automatic unlocking device for a vehicle 1, then, the monitoring device 2 shifts to a standby state, and stops operating. If the interior communication unit 22 receives an activation signal transmitted from the automatic unlocking device for a vehicle 1, then, the monitoring device 2 is activated from the standby state and resumes the stopped operation. Note that “standby state” is a state in which power consumed by the monitoring device 2 is lower than in the activation state, and only part of functions of the interior communication unit 22 operates, such as monitoring a signal transmitted from the automatic unlocking device for a vehicle 1.

An in-vehicle camera 23a, a proximity sensor 23b, a radar 23c, and a sound sensor 23d are connected to the input/output unit 23, and operations of various devices are controlled by the monitoring controller 21.

The in-vehicle camera 23a captures an image of the periphery of the vehicle, and outputs data on the captured image to the monitoring controller 21. A monocular camera or a stereoscopic camera can be used as the in-vehicle camera 23a. The in-vehicle camera 23a may also capture an image of a suspicious person with visible light, or may also capture an image of a suspicious person with infrared rays. The monitoring controller 21 acquires image data from the in-vehicle camera 23a via the input/output unit 23.

The proximity sensor 23b detects suspicious persons and obstacles around the vehicle by ultrasonic waves or infrared rays, for example, and outputs the detection result to the monitoring controller 21. The proximity sensor 23b is provided on both sides in the width direction of a front portion or a rear portion of the vehicle C, or at a substantially central portion in the width direction of the front portion or the rear portion of the vehicle C. Note that a clearance sonar may be utilized as the proximity sensor 23b configured to detect the suspicious persons and obstacles.

The radar 23c is a millimeter wave radar, a laser radar, or an ultrasonic radar, for example, detects suspicious persons and obstacles that are present relatively far away, and outputs the detection result to the monitoring controller 21.

The monitoring controller 21 identifies or detects suspicious persons, obstacles, and the like that are present around the vehicle by analyzing the acquired image data, and the results detected by the proximity sensor 23b, the radar 23c, and the sound sensor 23d. The suspicious person and the obstacle are identified by deep learning, for example. Deep learning is one type of machine learning, and classifies the images and the results detected by the sensors into predetermined classes. The monitoring controller 21 learns a large amount of object images of obstacles such as walls and blocks near the vehicle doors, object images of suspicious persons, object images of objects such as buildings and vehicles around the vehicle, and movement patterns of the object images, and stores the characteristics of suspicious persons and obstacles and classes corresponding to their characteristics as the learning results. The monitoring controller 21 specifies a class to which an object to be detected belongs, based on the acquired image data, the results detected by the sensors, and the learning results. Whether or not the object to be detected is a suspicious person and the types and the like of suspicious person and obstacle are specified by specifying the class. The monitoring controller 21 transmits the detection results related to suspicious persons and the like, such as whether a suspicious person and an obstacle are present, and the types of suspicious person and obstacle, to the automatic unlocking device for a vehicle 1 using the interior communication unit 22.

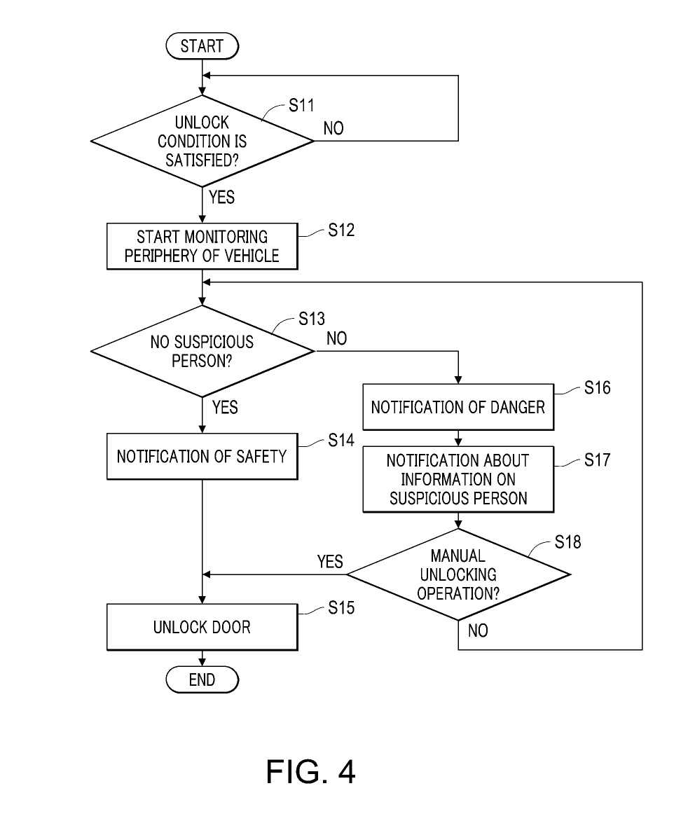

FIG. 4 is a flowchart showing a procedure of processing performed by the controller 11 according to automatic unlocking. The controller 11 determines whether or not a predetermined unlock condition is satisfied, based on the signals that are input to the input unit 15 from the gear position detection switch 15b and the ignition switch 15c, for example (step S11). The predetermined unlock condition corresponds to the predetermined movement stop state according to this aspect (1). An example of the unlock condition is a state in which the vehicle speed is zero, the ignition switch 15c is in the off state, and the shift position of the shift lever is in parking.

If the in-vehicle reception unit 13 receives the unlocking operation signal transmitted from the portable device 4, the authentication of the portable device 4 has succeeded, and the in-vehicle reception unit 13 detects that the portable device 4 is present in the vehicle, through wireless communication, the controller 11 may also determine that the predetermined unlock condition is satisfied.

Furthermore, if the ignition switch 15c is in the off state and the controller 11 detects that the door knob of the driver seat is operated with the driver seat door knob switch 15d, then, the controller 11 may also determine that the predetermined unlock condition is satisfied.

If it is determined that the unlock condition is not satisfied (step S11: NO), then, the controller 11 returns processing to step S11. If it is determined that the unlock condition is satisfied (step S11: YES), then, the controller 11 causes the interior communication unit 16 to transmit the activation signal to the monitoring device 2, thereby activates the monitoring device 2, and causes the monitoring device 2 to start monitoring the periphery of the vehicle (step S12).

Next, the interior communication unit 16 receives the detection result that is transmitted from the monitoring device 2 and related to suspicious persons and the like, and the controller 11 determines whether or not suspicious persons and obstacles are not present, based on this detection result (step S13). Note that the controller 11 configured to execute processes in steps S12 and S13 corresponds to the monitoring unit according to the above-described aspect (1).

If it is determined that no suspicious person or obstacle is present (step S13: YES), then, the controller 11 gives a notification that the outside of the vehicle is safe, using the speaker 19a, the interior light 19b, and the display unit 1.9c, for example (step S14). For example, the speaker 19a outputs the sound “please open the door”. The interior light 19b is also caused to emit blue light. Note that the controller 11 configured to execute the process in step S14 corresponds to the safety state notification unit.

The controller 11 causes the driving unit 18 to output the unlocking driving signal to the door locking device 18a, and causes the door locking device 18a to unlock all of the doors of the vehicle C (step S15), and ends processing.

If it is determined, in step S13, that a suspicious person or obstacle is present (step S13: NO), then the controller 11 gives a notification that the outside of the vehicle is dangerous, using the speaker 19a, the interior light 19b, and the display unit 19c, for example (step S16). For example, the speaker 19a outputs the sound “please wait because there is danger”. The interior light 19b is also caused to emit red light. The controller 11 also gives a notification of the type of suspicious person and obstacle, using the speaker 19a, the interior light 19b, and the display unit 19c, for example (step S17). For example, if a suspicious person is detected around the vehicle, the speaker 19a outputs the sound “there is a suspicious person”, and if an obstacle is detected, the speaker 19a outputs the sound “there is an obstacle”, for example.

Note that the controller 11 configured to execute the processes in steps S16 and S17 corresponds to the dangerous state notification unit according to the above-described aspects (2) and (3).

Next, the controller 11 determines whether or not a manual unlocking operation has been performed using the central locking switch 15e (step S18). Note that the controller 11 configured to execute the process in step S18 corresponds to the unlocking operation detection unit according to the aspect (4). If it is determined that the manual unlocking operation is not performed (step S18: NO), then the controller 11 returns processing to step S13. If it is determined that the manual unlocking operation has been performed (step S18: YES), then the controller 11 causes the door locking device 18a to unlock all of the doors of the vehicle C (step S15), and ends the processing.

Although an example in which the doors are unlocked with the central locking switch 15e was described herein, a configuration may also be adopted in which if a door lock mechanical switch provided on each door is operated, the door is unlocked.

According to the automatic unlocking device for a vehicle 1 having such a configuration, it is possible to monitor suspicious persons around the vehicle in a predetermined movement stop state in which the user possibly gets off the vehicle, confirm that there is no suspicious person, and automatically unlock doors of the vehicle. Thus, it is possible to prevent crimes or accidents that are caused by the user opening a door without paying attention to the periphery of the vehicle, and to improve the safety of the user.

Also, if a suspicious person is detected, the automatic unlocking device for a vehicle 1 can keep the doors locked, and give a notification of danger. Thus, the user can recognize that the doors are not automatically unlocked due to some kind of danger outside the vehicle, rather than that there is malfunction in the automatic unlocking function.

Furthermore, the automatic unlocking device for a vehicle 1 can give a notification of the types of suspicious person and obstacle. Thus, the user can recognize what kind of danger exists outside the vehicle and why the doors are not automatically unlocked. For example, the user can recognize the cause of danger, such as an obstacle that may collide with a door of the vehicle when the door is opened, or a suspicious person being present.

Moreover, even in a situation in which a suspicious person is detected and the doors are kept locked, the automatic unlocking device for a vehicle 1 can unlock the doors by operating the central locking switch 15e. Thus, even in a situation in which the automatic unlocking device for a vehicle 1 judges the outside is dangerous, if the user can confirm the safety outside the vehicle, the user can unlock the doors with his or her intention.

Furthermore, if no suspicious person is detected, the automatic unlocking device for a vehicle 1 can give a notification of safety. Thus, the user can recognize that the outside of the vehicle is in a safe state,

### REFERENCE SIGNS LIST

1 Automatic unlocking device for vehicle

1a RF reception antenna

2 Monitoring device

3 LF transmission antenna.

4 Portable device

11 Controller

12 In-vehicle transmission, unit

13 In-vehicle reception unit

14 Storage unit

15 Input unit

15a Vehicle speed sensor

15b Gear position detection switch

15c Ignition switch

15d Driver seat door knob switch

15e Central locking switch

16 Interior communication unit

17 Timer unit

18 Driving unit

18a Door locking device

19 Output unit.

19a Speaker

19b Interior light

19c Display unit

21 Monitoring controller

22 Interior communication unit

23 Input/Output unit

23a In-vehicle camera

23b Proximity sensor

23c Radar

23d Sound sensor

C Vehicle

1. An automatic unlocking device for a vehicle configured to automatically unlock a locked door of the vehicle if the vehicle is in a predetermined movement stop state, the automatic unlocking device for a vehicle comprising one or more processors and memory configured to perform the following:
monitor a suspicious person around the vehicle if the vehicle is in the predetermined movement stop state; and
keep the door locked if a suspicious person is detected, and to unlock the door if no suspicious person is detected; and
give a notification of danger if a suspicious person is detected and the door is kept locked,
wherein the monitoring involves monitoring a suspicious person and an obstacle around the vehicle, and
the notification gives a notification of at least a type of suspicious person or obstacle detected.

2. (canceled)

3. (canceled)

4. The automatic unlocking device for a vehicle according to claim 1, comprising:
the one or more processor and memory are further configured to detect an operation for unlocking the door,
wherein the one or more processor and memory are configured to unlock the door if the door is kept locked in the predetermined movement stop state and the unlocking operation is detected.

5. The automatic unlocking device for a vehicle according to claim 1, comprising:
the one or more processor and memory are further configured to give a notification of safety if no suspicious person is detected.

6. The automatic unlocking device for a vehicle according to claim 4, comprising:
the one or more processor and memory are further configured to give a notification of safety if no suspicious person is detected.

7. An automatic unlocking device for a vehicle comprising:
a door configured to be electronically unlocked;
one or more processors and memory configured to perform the following:
evaluate vehicle sensor data to determine if the vehicle is in a predetermined movement stop state;
evaluate environment sensor data to monitor for a suspicious person around the vehicle if the vehicle is in the predetermined movement stop state; and
keep the door locked if a suspicious person is detected, and automatically unlock the door if no suspicious person is detected; and
give a notification of danger if a suspicious person is detected and the door is kept locked,
wherein
the monitoring involves monitoring a suspicious person and an obstacle around the vehicle, and
the notification gives a notification of at least a type of suspicious person or obstacle detected.
